(19) United States
(12) Patent Application Publication
(10) Pub. No.: US 2013/0212615 A1
(43) Pub. Date: Aug. 15, 2013

(54) GATEWAY REMOTE CONTROL SYSTEM AND METHOD OF OPERATION

(71) Applicant: Mark Alan Schultz, Carmel, IN (US)

(72) Inventor: Mark Alan Schultz, Carmel, IN (US)

(73) Assignee: THOMSON LICENSING, Issy de Moulineaux (FR)

(21) Appl. No.: 13/881,002

(22) PCT Filed: Nov. 10, 2010
(86) PCT No.: PCT/US10/02941

§ 371 Date: Apr. 23, 2013

(51) Int. Cl. H04N 21/475

(52) U.S. Cl. CPC H04N 21/4753
USPC 725/25

(57) ABSTRACT

A gateway is communicatively coupled between content source devices for a home entertainment network and playout devices included in the network, the gateway making use of available user, system, and other preferences of for example, respective control devices in the home entertainment network to enable controlled access of content in the network. For example, a personalized remote control device communicates with a gateway, either directly or indirectly, in a home entertainment network such that a user associated with the personalized remote control can interact personally with the gateway to modify viewing content in accordance with the specifications, preferences, and requirements for that particular user. As such, an entertainment device in communication with the personalized remote control device in the home network can be personalized for a user without the need to program and reprogram each and every entertainment device to a user's respective specifications, preferences, and requirements.

### CROSS-REFERENCE TO RELATED APPLICATION

The present application for patent is related to U.S. Patent Application Attorney Docket No. PU100113 filed by this inventor and filed simultaneously herewith and entitled “Individualized Program Guide Based On System And User Constraints”. The teachings of the above-identified patent application are expressly incorporated herein by reference.

### TECHNICAL FIELD

The present invention relates generally to home entertainment networks and, more particularly, to coordinating and controlling network access and local access to specific content through a gateway remote control system.

### BACKGROUND OF THE INVENTION

A large number of entertainment devices are found in a typical home. These entertainment devices include, but are not limited to, televisions, set top boxes, digital video recorders, personal video recorders, DVD players, home theater systems, and the like. Each entertainment device has the capability of being programmed by one or more users for parental controls, viewing preferences, general access, interaction between units, and other such operational features. Home entertainment networks have been developed to integrate and coordinate the operation of many of these different devices.

Many of these entertainment devices can be operated remotely by using a remote control device. Although each entertainment device is furnished by the manufacturer with its own remote control device, it is possible to program general purpose remote control devices to interact with many different types of the entertainment devices. Even though the number of remote control devices can be reduced in a home network, there is still a need for each user to program his or her own profile to include access controls, viewing preferences, and other operational features for each separate device in the home network.

In many cases, entertainment devices have the capability for storing only one such profile at a time and maintaining that profile as operational for the household until it is erased or modified. When a user personalizes one or more entertainment devices to fit his or her viewing preferences, any existing preferences stored for a prior user are generally erased because the device can only maintain a single profile of preferences at any given time. Hence, each user in a multi-user household must enter and re-enter their specific preferences when their profiles have been erased by another user in the intervening times between a user's viewings. When this type of single profile device proliferates in the network, the overall system becomes unwieldy and even more inconvenient when there are only several members of the same household with different viewing preferences because of the need to program and reprogram to suit the preferences of each particular viewer.

In all these entertainment devices, the user preferences are generally restricted to operate on and pertain to the device that stores the preferences. There is no known technique or apparatus for allowing a user's preferences to be shared with other entertainment devices accessible by the particular user within the same network.

### SUMMARY OF THE INVENTION

Availability of user, system, and other preferences or profiles on all devices in a content distribution environment, such as a home entertainment network, and a concomitant control of access to the network are both achieved in the home entertainment network by employing a gateway communicatively coupled between the content input devices for the network and the entertainment devices in the network in accordance with embodiments of the present invention. In one embodiment, user access is regulated by a remote control device and a device protocol in which the remote control device both communicates with the gateway to identify at least a particular user in the household and requests network access to view content on a particular entertainment device. The gateway device then is able to authenticate the user and the user request and to apply appropriate profiles or preferences based at least on one of the particular authenticated user, the particular entertainment device identified for viewing content, and the location of the particular entertainment device within the home network.

In one embodiment of the present invention, a method for controlled content distribution in a content distribution network including a gateway communicatively connected to one or more content playout devices includes receiving at the gateway a request for content from a control device in communication with at least one playout device, the request including at least an identification of a user associated with the control device from which the request was sent, comparing the user identification with at least one stored profile for at least one of the user and the network to determine whether to process the request for content, determining which content playout device of the one or more content playout devices is associated with the control device sending the request for content, generating a set of preferences based on the at least one stored profile for at least one of the determined content playout device, the user, and the network, wherein the set of preferences are available to the gateway, and when a determination is made to process the request for content, delivering content to the content playout device, the content being defined in accordance with the set of preferences.

In an alternate embodiment of the present invention, a system for controlled content distribution includes at least one content source for providing content and a gateway for receiving a request for content from a control device in communication with at least one playout device, the request including at least an identification of a user associated with the control device from which the request was sent, comparing the user identification with at least one stored profile for at least one of the user and the network to determine whether to process the request for content, determining which content playout device of the one or more content playout devices is associated with the control device sending the request for content, generating a set of preferences based on the at least one stored profile for at least one of the determined content playout device, the user, and the network, wherein the set of preferences are available to the gateway and when a determination is made to process the request for content, delivering content from the at least one content source to the content playout device, the content being defined in accordance with the set of preferences. The system of the present invention can further include at least one control device associated with at least one playout device for enabling a user to communicate content requests and at least one playout device for rendering received content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a home entertainment network in accordance with an embodiment of the present invention; and

FIG. 2 depicts a high level block diagram of a layout of a home entertainment network in accordance with an embodiment of the present invention in a home environment depicting movement of users;

FIG. 3 depicts a high level block diagram of the layout of the home entertainment network of FIG. 2 depicting different user movement;

FIG. 4 depicts a high level block diagram of a home entertainment network in accordance with an alternate embodiment of the present invention; and

FIG. 5 depicts a flow diagram of a method for controlled content distribution in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION

The present invention advantageously provides a method and apparatus for content control and distribution in, for example, a home entertainment network. Although the present invention will be described primarily within the context of a home entertainment network, the specific embodiments of the present invention should not be treated as limiting the scope of the invention. It will be appreciated by those skilled in the art and informed by the teachings of the present invention that the concepts of the present invention can be applied to substantially any network for the control and distribution of content.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

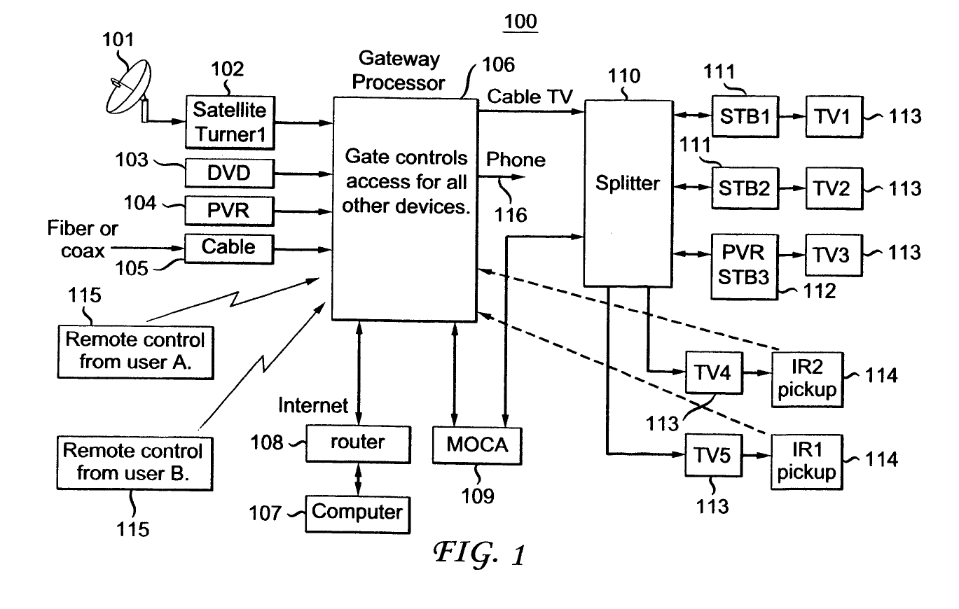

FIG. 1 depicts a high level block diagram of a home entertainment network in accordance with an embodiment of the present invention. The home entertainment network 100 of FIG. 1 illustratively includes a receiving antenna 101, satellite tuner 102, a DVD player 103, a PVR 104, a cable TV device 105, a residential gateway 106, a router 108, a splitter 110, a MoCA connection 109, a phone 116, a plurality of entertainment/display devices 113, IR pickup devices 114, set top boxes (STB) 111 and 112, and remote control devices 115. Also included among the entertainment devices is a computer 107, which is connected to the gateway 106 via a router 108. The computer 107 is capable of both providing content like an input device, requesting content like a remote control device, and presenting content like an output device. Televisions 113 are connected to the gateway via the splitter 110 either directly or indirectly (i.e., through the set top boxes 111 or 112). Many of the devices shown in FIG. 1 are well known in the art and need no further explanation herein. Background information about the basic functionality of many of these devices can be found in the Smyth article cited above and in U.S. Patent Application Publication Nos. 2007/0136752 to Sanders and 2009/0187845 to Beck and in U.S. Pat. No. 6,721,954 to Nickum, all of which are incorporated herein by reference in their entirety. Although not shown in the figures, it should be understood that the gateway 106 includes one or more storage devices together with a filtering capability, all of which are described in more detail in co-pending and commonly filed patent application Attorney Docket No. PU100113, entitled “INDIVIDUALIZED PROGRAM GUIDE BASED ON SYSTEM AND USER CONSTRAINTS”, which was identified at the beginning of this patent application and incorporated herein by reference, in its entirety.

The cable device 105 can be realized in an exemplary embodiment as an xDSL device, a wireless service connection, or simply a cable connection (i.e., point of presence). Other similar realizations are understood by persons skilled in this art area. Connections between the gateway 106 and STBs via standard cable or in conformance to standards set by the Media over Coax Alliance (MoCA) can provide a sufficient platform for such backbone communications and device control in the home entertainment network.

In the various embodiments of the present invention, the televisions 113 should be understood as being either a standard television receiver or a display device. Since a standard television may exhibit significantly less functionality than some intelligent televisions, it is intended that any reference to a television also includes a set top box or computer processor or other processing element combined communicatively with a monitor or display or television receiver or the like.

In one embodiment, the residential gateway 106 is positioned as a central point in the home entertainment network between input devices and output devices. It can act as a gatekeeper in the information flow between the input devices and the output devices. In this way, the gateway can control user access to the network and to content, as well as availability and distribution of user preferences for the entertainment devices in the home entertainment network. Exemplary input devices, such as devices 101-105, in the exemplary network of FIG. 1 provide content as well as content information such as electronic program guide information and the like. Typically, electronic program guide information and the associated content are available from the satellite and cable content providers, whereas content and some related content information, perhaps in the form of associated metadata, are provided by the DVD 103 and PVR 104. Output devices are generally understood to encompass devices which receive and display the content and content information. The output devices can include such exemplary devices as set top box and display device combinations, stand alone monitors or television receivers, and computer and monitor combinations. It should be understood that other output devices can be utilized for realization of the network in FIG. 1.

The residential gateway 106 of FIG. 1 receives content and content related information from one or more of the input devices. It should be understood that throughout the teachings herein, any references to the term “content” include any combination of content and content related information, without further limitation or modification. The content related information describes available content and can be presented in a particular format such as an electronic program guide or the like. Many formats are possible for the content related information. Obviously, one format is the well-established table format. Other formats are presented in on-line video guides such as the one from the TV Guide website, guides and listings from third party media providers such as Netflix®, formats or direct links or shortcut links to media files, directory listings in applications such as iTunes® from Apple Computer, and computer listings or directories for media copied to, and stored in, a computer connected to the home entertainment network.

The gateway 106 extracts the content information from the content of all the input devices as it is received. Content information from the DVD 103 and PVR 104 is suitable for formatting by the gateway 106 into an electronic program guide format. In various embodiments of the present invention, a communication path is established between a user and the gateway 106 via, for example, the remote control device 115 in at least one direction. The user initiates the interaction with the gateway 106 by turning on a display device or by making a request for content or guide information via a displayed menu or the like. Such a communication can also involve a request for access to the system. In one embodiment, a user's communications from the remote control device 115 include an identification of the particular user or associated devices.

When such a communication is received by the gateway 106, a user request can initiate an authentication procedure in the gateway 106. That is, in one embodiment of the present invention, the authentication can include having a user provide user identification and then having the gateway check the authenticity of that identification. In alternate embodiments, the authentication process can be as rigorous as requiring an identification and a password, which are both associated with the user identification, to be properly provided to the gateway by the user. Once the gateway 106 determines the authenticity of the user by verifying the provided identification and password, such as by comparison to previously stored copies of the same information in a set of user or network usage rules, the user is granted access to the system. Otherwise access to the system and grant of the user request are denied. In an alternate embodiment, the user identification and the password for use by the gateway 106 can be stored in a user profile in a storage means for the gateway 106. Many authentication procedures, which are initiated by a user request and can be incorporated into embodiments of the present invention, are well known in the art and will not be explained further herein.

Control of many, if not all, functions for the entertainment devices in the network via the gateway in accordance with various embodiments of the present invention provides a unified approach to simplify and personalize operation of all entertainment content and devices in a system in accordance with the present invention. In an entertainment system, such as the home entertainment network 100 of FIG. 1, each user issues commands for content on a particular playout/entertainment device 111, 112, 113 from, for example, a remote control device 115. Instead of interacting directly with the desired playout/entertainment device 111, 112, 113, in the embodiment of the present invention of FIG. 1, the remote control device 115 communicates with the gateway 106, either directly or indirectly through another networked device, and then the gateway responds to the user requests by controlling the content on the desired playout/entertainment device in accordance with that user's specifications, preferences, and requirements, as well as in accordance with the specifications and capabilities of the playout/entertainment device itself. In certain instances, the gateway 106 also processes the user requests in accordance with other attributes related to the user's desired playout/entertainment device including its location in the home entertainment network, which will be described in more detail below.

For example, in one embodiment of the present invention, viewing preferences for all network users are unified on the gateway and are accessible when a remote control device is in communication directly or indirectly with the gateway. The preferences, which are stored in a local storage means to the gateway or a remote storage means in communication with the gateway, are then accessed and used by the gateway when a remote control device provides a unique identification for that specific viewer. More specifically, in the above described embodiment of the present invention, a respective remote control device identifies a user and user preferences stored for that user are identified and used by a gateway of the present invention for determining what content and what features of the entertainment system can be accessed by a user associated with that remote control device.

For example, in one embodiment of the present invention, the unique identification can be at least one of an identification of the particular user for the remote control device and a location of the remote control device and the playout/entertainment device on which content is requested. The gateway of the present invention can apply the particular user's preferences to the user request for content while communicating with the playout/entertainment devices downstream of the gateway to carry out all of the requests from the viewer without affecting the other views or preferences of additional users in the household using alternate playout/entertainment devices.

A personal remote control device, in accordance with various embodiments of the present invention, communicates with a gateway, either directly or indirectly, in a home entertainment system such that each user can interact uniquely with the gateway to modify viewing content in accordance with the specifications, preferences, and requirements for that particular user. In this way, a playout/entertainment device in a home network can be personalized for a user without the need to program and reprogram each and every playout/entertainment device to the user's own specifications, preferences, and requirements. Network devices in the network that are downstream of the gateway can then be controlled by the user's interactions through the gateway to simplify and improve the operation and control of display and playout/entertainment devices in the network.

To elaborate, in various embodiments of the present invention, remote control devices for use with a gateway in the network are adapted to provide an identification of the user. For example, in one embodiment, a remote control device is personalized and unique for each authorized user in the network. In an alternate embodiment of the present invention, a remote control device is interchangeable among users so that, when the network is properly accessed by a user via the gateway, the remote control device and the entertainment devices operate as though they are unique to that user. In such an embodiment, a user can identify themselves to the gateway via a password or other identification means. Ultimately, each type of remote control device is capable of being associated with a particular user by the gateway because the user is identified to the gateway automatically or manually using the remote control device. With these types of remote control devices and their association and communication with a gateway in accordance with the present invention, the home entertainment network becomes much easier to operate and thereby personalized to the preferences for each user on each device in the network.

In accordance with the concepts of the present invention, regardless of the entertainment device being accessed or its location, the remote control device identifies the user to the gateway so that the personalized and household preferences and viewing choices such as formats, sound volume, or personalized electronic program guides, among others, can be accessed by the gateway and applied for the specific user at the playout/entertainment device that is currently associated with that user. Once a user has been identified and authenticated, if necessary, by the gateway, it is also possible to access other features, device and network features, such as, for example, automatically resuming playback of recorded content or a DVD from the last time this particular user watched the content. It is also possible to share or switch viewable content on any entertainment device in the home network even if the person has moved from one room to another since the content distribution is controlled by the gateway. Movement of a viewer or user can be monitored by tracking the location of the user's remote control device. This feature will be discussed in more detail below.

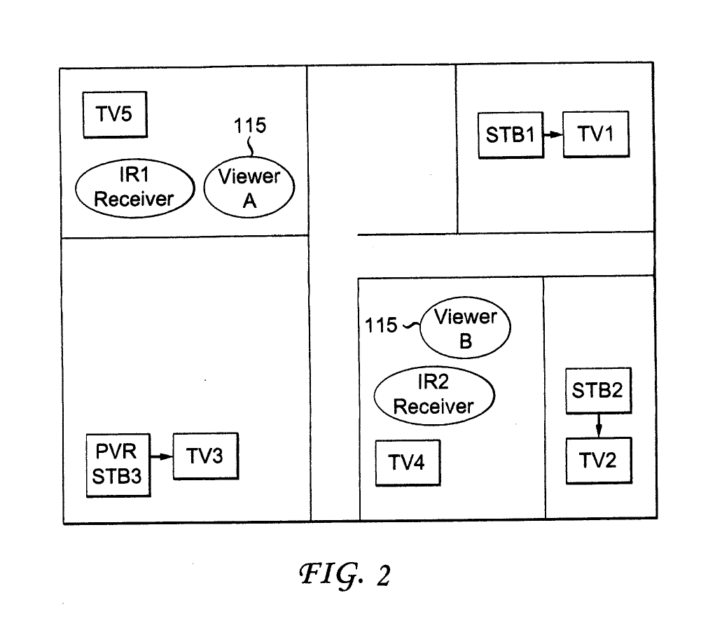

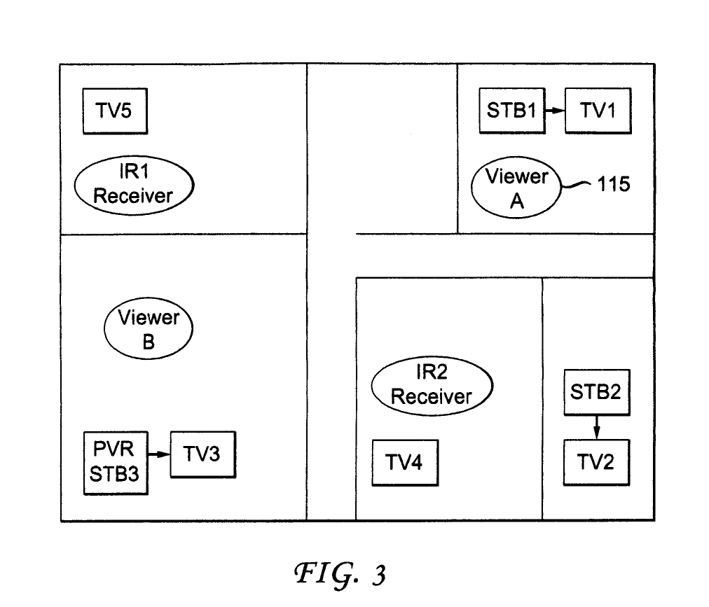

For example, FIG. 2 depicts a high level block diagram of a layout of a home entertainment network in accordance with an embodiment of the present invention in a home environment depicting movement of users and FIG. 3 depicts a high level block diagram of the layout of the home entertainment network of FIG. 2 depicting different user movement. For example, as Viewer A moves around the house as depicted in FIGS. 2 and 3, the viewer's content can move with Viewer A. For example, FIGS. 2 and 3 show a simplified floor plan in which viewers are identified and are shown as occupying different rooms from one figure to the next. Even though Viewers A and B move around the house with their respective remote control devices 115, gateway 106 controls access and tracks the views to enable each viewer to continue viewing their related program from another location while, in one embodiment, discontinuing viewing from the previous location. For example, when Viewer A moves from TV5 in FIG. 2 to STB1 and TV1 in FIG. 3, Viewer A is able to continue viewing the same content on TV1, which was previously available on TV5. In the embodiment of FIGS. 2 and 3, content for Viewer A is no longer delivered to TV5. This operational capability is possible because the viewer has a unique user identification that is communicated to the gateway 106 via the remote control device 115. The STB that the viewer is interacting with also has a unique identification in the network so gateway 106 knows the identities of both the viewer/user and the STB associated with that user. When Viewer A changes room locations, the identity of the STB in the new location is forwarded to the gateway allowing the gateway to pair up Viewer A remote control device and the newly accessed entertainment device (in this example, STB1 and TV1).

In one embodiment of the present invention, when a child takes a remote control device programmed for an adult's preferences into the child's room and tries to access inappropriate content, no content will be permitted for viewing by the child. That is, because of the preferences assigned to the entertainment devices in the child's room in accordance with the present invention, no such content is permitted for viewing, even though the adult remote control device would be capable of accessing such content in other rooms of the house. Moreover, in alternate embodiments of the present invention, a network preference or profile would also disallow such content from being displayed at the location identified as the child's room. Using one or more of these profiles, the gateway 106 would override any adult preferences for the adult user associated with the remote control device by using the appropriate network and/or device preferences or profiles and thereby disallow delivery of inappropriate content to the entertainment devices (e.g., STB) in a child's room.

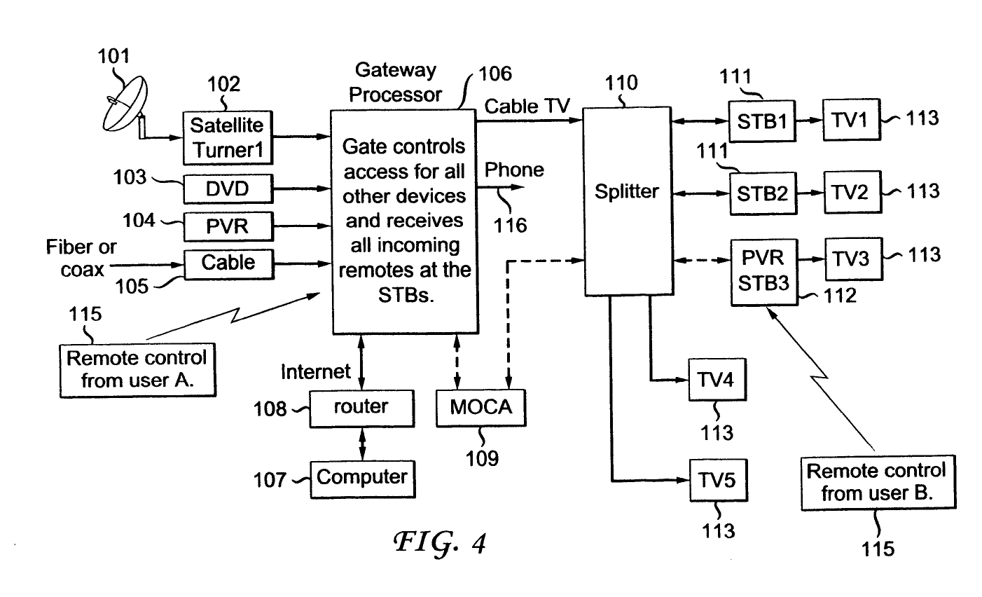

As mentioned above and well known in the art, most remote control devices are limited to communicate with, and to control, the entertainment device for which they are specifically manufactured. In accordance with various embodiments of the present invention, the remote control devices as shown in the figures herein (see FIG. 1) communicate directly or indirectly (see FIG. 4) with the gateway 106. Indirect communication between a remote control device and the gateway is facilitated by an intermediate device such as an infrared (IR) or radio frequency (RF) pickup transceiver 114, either in communication with the entertainment device or integrated into the entertainment device. This intermediate device acts like an intelligent repeater by intercepting requests and commands transmitted by the remote control device and forwarding these requests and any other remote control device responses to the gateway 106. The intermediate device may also combine or package its own identification or location information with the remote control request/response so that the gateway 106 can establish an approximate location or room in the household in which the remote control device and the intermediate device are located. Since the gateway may already know the location of the intermediate device based on device profiles, a network profile, and a network map established, in one embodiment, during the initialization and/or operation of the home entertainment network, it may be required that the intermediate device only provide its device identification to the gateway without any need for specific location information. That is, in accordance with embodiments of the present invention, because the gateway has knowledge of the location of each entertainment device in the home entertainment network, it is possible to track the location of a remote control device since the remote control device requests content for viewing on a particular entertainment device and can even have its requests forwarded to the gateway by a particular intermediate device that is either integrated with or communicatively coupled to a particular entertainment device.

The remote control of the various embodiments of the present invention provides a unique identification corresponding to a network user while in communication with the gateway so that the gateway can control content and access to content within the home entertainment network while personalizing the experience to the particular user through the use of the user's own preferences. As discussed above and as shown in FIGS. 1-4, the remote control device can communicate directly with the gateway via an infrared communication channel, an RF channel, a wireless channel, or the like. In alternate embodiments of the present invention, the remote control device can also communicate with a set-top box, which in turn communicates with the gateway, over RF or infrared or wireless communication channels.

In yet another alternate embodiment of the present invention, the remote control device can communicate with an intermediate communication device such as infrared pickup device, which in turn communicates with the gateway, over RF or infrared or wireless communication channels. While the more common form of intermediate communication device is shown in the FIGS. 1-4 as an IR (infrared) pickup transceiver 114, it should be apparent that the class of intermediate communication device can also include the set top box (STB) because it is positioned between the output display device and the gateway. The need for an IR pickup transceiver 114 is occasioned by a lack of an STB or some other similarly functioning device in the associated display device, which is usually a standard television display or receiver. When the remote control device is in communication with the intermediate communication device, the remote control device is said to be in indirect communication with the gateway and the instant intermediate communication device effectively serves as a proxy for the remote control device by passing to the gateway various identification information about the remote control device. In addition, the STBs and most intermediate communication devices are capable of providing their own device identification to the gateway. Upon receipt of such device identification, the gateway is able to use stored information from network or device or household profiles to determine a location of the identified entertainment device and the associated remote control device within the home entertainment network.

In an alternative embodiment, the remote control device and the intermediate communication device associated with the output device, on which the user wishes to view content, can both be simultaneously in communication with the gateway. For example, the remote control device could be communicating commands with the gateway via an RF link, while the same commands could be picked up from the remote control device over an IR link for a display device in a particular room. The gateway, upon receipt of the commands from the remote control device, both directly and indirectly (via the IR pickup device), can correlate or match the received commands to identify the remote control device and the output device (connected to the IR pickup device) on which the user wishes to view content because the commands are either the same or substantially identical.

In at least one embodiment of the present invention, minors in a household to have different remote control devices than an adult's remote control device to institute age appropriate viewing restrictions with respect to viewable content using the remote control device to identify the user. That is, in various embodiments of the present invention, a special profile for children can be provided to the gateway so that viewable content or listings of such content can be child friendly. The minor's remote control device itself or in conjunction with the gateway responses can have a limited functionality to further restrict the availability to content that is inappropriate for certain age groups. Limitation of program listings and electronic program guide information is covered in the co-pending and commonly filed patent application Attorney Docket No. PU100113, entitled “INDIVIDUALIZED PROGRAM GUIDE BASED ON SYSTEM AND USER CONSTRAINTS”, which was identified at the beginning of this patent application and incorporated herein by reference, in its entirety.

More specifically, in accordance with the concepts of the present invention, once the gateway 106 recognizes which user is sending remote commands from the remote control device 115 and which output device is associated with the remote control device sending the commands, parameters can be generated from profiles stored on the gateway 106 and then communicated by the gateway 106 and finally loaded on the identified entertainment output device to provide user, device, and network preferences such as those described herein. If a phone 116 is included in the home network, the gateway 106 can forward calls directly to the room of the viewer without disturbing others in the household. Due the inventive use of the gateway 106 in the home entertainment network in accordance with the concepts of the present invention, access to content, even content directed over telephone lines, follows a user from room to room, under control of the gateway 106, based on profiles stored therein.

In various embodiments of the present invention, remote commands can arrive over various communication paths and are delivered to the gateway for control of the network as shown in FIGS. 1 and 4. For example, when a user sends commands from a remote to the gateway of the present invention, user identification can be accomplished by the gateway but location cannot be derived without further information unless the remote control device includes GPS or some other positioning functionality to generate position information for transmission to the gateway. When a user sends commands to the set top box, the gateway receives both device and user information from which both the output device associated with the remote control device and the location of the remote control and the output device can be derived. When a user sends commands to the IR pickup transceiver connected to a television, the gateway receives both device and user information from which both the output device associated with the remote control device and the location of the remote control and the output device can be derived. When a user sends commands from a computer to the gateway, the gateway receives both device and user information from which both the output device associated with the remote control device and the location of the remote control and the output device can be derived unless the computer is a mobile device such as a laptop or the like. In the latter case, location information is supplied to the gateway from the mobile computer. In alternate embodiments of the present invention, remote control commands can be sent to the gateway via a telephone connection. In this case, the output device and therefore its location would be identifiable by the gateway.

In accordance with embodiments of the present invention, preferences can be separated into user-based preferences and system-based preferences. These preferences include a number of different criteria. For example, some criteria for user-based systems can include user identification, time slots, dates or days, channels, specific programs, content ratings, locations for viewing, parental control information, and the like. System-based criteria can include configuration information for the home network, viewing device location and the like. In a broader application of these concepts, the criteria can also include: media identification including any descriptive information for media such as music, software applications, literature, and the like; electronic addresses such as IP or URL addresses for websites and services offered thereon; identification and descriptive information for interactive Internet applications including web games and the like; download information for software and content downloads; and telephone number information including the entire phone number, address, and name associated with the number. In accordance with various embodiments of the present invention, the above identified preferences can be included in profiles stored in the gateway.

In accordance with the present invention, user profiles can be stored in an internal or external memory/storage device for the gateway 106. That is, a storage device can be integrated into the gateway 106 or it can be external to the gateway 106. In such embodiments, each user profile is associated with a particular network user or a group of such users. In one embodiment of the present invention, a user profile can include an identification of the user or the user group as well as authentication information such as a password. The user profile can also include other personal information about the user such as age, viewing rights such as a restriction on allowable program rating, allowable program genre, allowable broadcast channels, for example, viewing preferences such as volume, screen format (standard versus HDTV, for example), picture-in-picture stations such as a monitor from a baby's room, security information, and the like, time limits for viewing in terms of a maximum amount of viewing time within a certain time period such as a day or week, for example, time periods for viewing such as from 3-6 PM on weekdays and from 12-10 PM on weekends, and other related parameters. User profiles can be generated according to a single user or a user group. In embodiments of the invention, such as for minor children, a user profile can be generated by a parent or guardian or an authorized proxy. In alternate embodiments of the present invention, certain portions of a user profile can be established by the gateway or the network. For example, default profiles can be made available to, or initially established for, each user and user group. It should be noted that, throughout this description, a profiles of the present invention, as described above, can also be referred to as setup information or usage rules or preferences.

In various embodiments of the present invention, a network profile identifies an output entertainment device (such as an STB and its associated output display device), the device operational parameters, and the location of the devices in the home network and on the premises. Other information contained in a network profile can be similar to the information found in the user profile including: network preferences such as viewing rights on the output device such as a restriction on allowable program rating, allowable program genre, allowable broadcast channels, and the like; time limits for viewing on the output device in terms of a maximum amount of viewing time within a certain time period; time periods for viewing on the output device; information about the display device and its capabilities; information about the set top box (STB) associated with the display (see FIG. 4), when an STB is used; and other related parameters including device parameters. Some information about the STB can also include the location and purpose with respect to each viewing user. An STB can provide access to the Internet, phone services, home intercom network, home monitoring and security networks, interactive games both inside and outside of the home, wireless web access, and possibly access to remote wireless video transmitters. In a home network environment of the present invention, a gateway is capable of controlling each STB based on the associated profile.

In one exemplary embodiment of a network or device profile of the present invention, a profile of an STB in a common area family room would contain few restrictions when the family is all home because, in most cases, adults can monitor the viewing content of children in the family room, whereas a profile of an STB in a child's bedroom would contain much more restrictions since viewing may not be as closely monitored in that personal space.

For example, it can be assumed that a child is attempting to access the content through an STB that is located in a room identified as a child's room. The associated STB is restricted in the system profile to show programs that bear less than a PG-13 rating. The child's user profile can contain defining parameters such as: age 10; male; no programs rated at or above PG-13; a maximum of 3 hours of viewing per day; educational content viewing permitted from 3-7 PM on school days; and viewing of Hannah Montana can only occur from 3-4 PM each day. The filtered set of program guide information rendered for, and presented to, this user, when the user is authorized on the display will be generated to only show program listings less than PG-13, only educational programs from 3-7 PM during the week, and also Hannah Montana only from 3-4 PM each day. All content viewing selections for this child are then controlled to be accessed from the filtered set presented to the child. The residential gateway via the filtered set of program guide information limits the access to all programs and acts as the controlling device to the household on a per individual or per monitor basis.

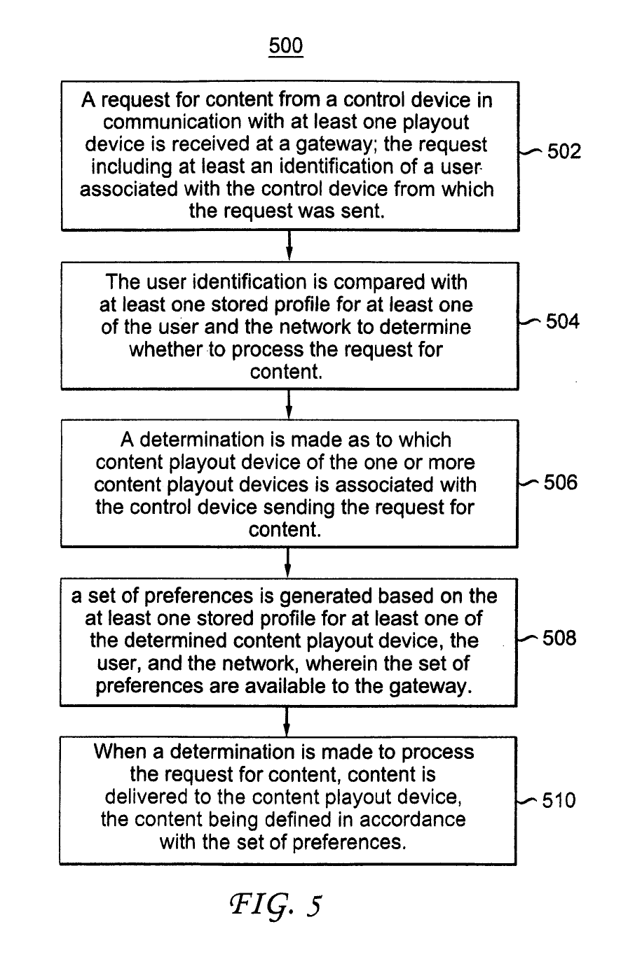

FIG. 5 depicts a flow diagram of a method for controlled content distribution in accordance with an embodiment of the present invention. The method 500 begins at step 502 during which a request for content from a control device in communication with at least one playout device is received at a gateway; the request including at least an identification of a user associated with the control device from which the request was sent. The method 500 then proceeds to step 504.

At step 504, the user identification is compared with at least one stored profile for at least one of the user and the network to determine whether to process the request for content. The method then proceeds to step 506.

At step 506, a determination is made as to which content playout device of the one or more content playout devices is associated with the control device sending the request for content. The method 500 then proceeds to step 508.

At step 508, a set of preferences is generated based on the at least one stored profile for at least one of the determined content playout device, the user, and the network, wherein the set of preferences are available to the gateway. The method 500 then proceeds to step 510.

At step 510, when a determination is made to process the request for content, content is delivered to the content playout device, the content being defined in accordance with the set of preferences. The method 500 can then be exited.

Having described various embodiments for a method and apparatus for content control and distribution in, for example, a home entertainment network (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for controlled content distribution in a content distribution network including a gateway communicatively connected to one or more content playout devices, the method comprising:
receiving at the gateway a request for content from a control device in communication with at least one playout device, the request including at least an identification of a user associated with the control device from which the request was sent;
comparing the user identification with at least one stored profile for at least one of the user and the network to determine whether to process the request for content;
determining which content playout device of the one or more content playout devices is associated with the control device sending the request for content ;
generating a set of preferences based on the at least one stored profile for at least one of the determined content playout device, the user, and the network, wherein the set of preferences are available to the gateway; and
when a determination is made to process the request for content, delivering content to the content playout device, the content being defined in accordance with the set of preferences.

2. The method of claim 1, wherein the method further comprises determining a location for both the control device and the content playout device associated with the control device.

3. The method of claim 1, wherein access to the content is denied based on the generated set of preferences.

4. The method of claim 1, wherein the method further comprises receiving at the gateway an identification of the content playout device associated with the control device issuing the request for content.

5. The method of claim 1, wherein the method further comprises authenticating the identification of the user.

6. The method of claim 1, wherein the method further comprises storing a profile for each user of the network and for each control device in the network.

7. The method of claim 1, wherein the request for content includes a request to deliver content to a content playout device not typically associated with the control device from which the request for content originated.

8. A system for controlled content distribution, comprising:
at least one content source for providing content;
a gateway for:
receiving a request for content from a control device in communication with at least one playout device, the request including at least an identification of a user associated with the control device from which the request was sent;
comparing the user identification with at least one stored profile for at least one of the user and the network to determine whether to process the request for content;
determining which content playout device of the one or more content playout devices is associated with the control device sending the request for content;
generating a set of preferences based on the at least one stored profile for at least one of the determined content playout device, the user, and the network, wherein the set of preferences are available to the gateway; and
when a determination is made to process the request for content, delivering content from the at least one content source to the content playout device, the content being defined in accordance with the set of preferences;
at least one control device associated with at least one playout device for enabling a user to communicate content requests; and
at least one playout device for rendering received content.

9. The system of claim 8, wherein said content source comprises at least one of a source of satellite content, a DVD player, a source of cable content, a personal video recorder and the internet.

10. The system of claim 8, wherein said control device comprises a remote controller.

11. The system of claim 8, wherein said playout device comprises a television set.

12. The system of claim 8, wherein said playout device comprises a computer.

13. The system of claim 8, wherein said profile is stored in a memory internal to the gateway.

14. The system of claim 8, wherein said profile is stored in a memory external to the gateway.

15. The system of claim 8, wherein a determined set of preferences defines what content can be delivered to an identified user.
